(19) United States
(12) Patent Application Publication
(10) Pub. No.: US 2016/0125094 A1
(43) Pub. Date: May 5, 2016

(54) METHOD AND SYSTEM FOR BEHAVIOR QUERY CONSTRUCTION IN TEMPORAL GRAPHS USING DISCRIMINATIVE SUB-TRACE MINING

(71) Applicant: NEC Laboratories America, Inc., Princeton, NJ (US)

(72) Inventors: Zhichun Li, Princeton, NJ (US); Xusheng Xiao, Plainsboro, NJ (US); Zhenyu Wu, Plainsboro, NJ (US); Bo Zong, Plainsboro, NJ (US); Guofei Jiang, Princeton, NJ (US)

(21) Appl. No.: 14/932,799

(22) Filed: Nov. 4, 2015

Related U.S. Application Data
(60) Provisional application No. 62/075,478, filed on Nov. 5, 2014.

(51) Int. Cl. G06F 17/30

(52) U.S. Cl. CPC G06F 17/30958; G06F 17/30917

(57) ABSTRACT

A method and system for constructing behavior queries in temporal graphs using discriminative sub-trace mining. The method includes generating system data logs to provide temporal graphs, wherein the temporal graphs include a first temporal graph corresponding to a target behavior and a second temporal graph corresponding to a set of background behaviors, generating temporal graph patterns for each of the first and second temporal graphs to determine whether a pattern exists between a first temporal graph pattern and a second temporal graph pattern, wherein the pattern between the temporal graph patterns is a non-repetitive graph pattern, pruning the pattern between the first and second temporal graph patterns to provide a discriminative temporal graph, and generating behavior queries based on the discriminative temporal graph.

### RELATED APPLICATION INFORMATION

This application claims priority to provisional application Ser. No. 62/075,478 filed on Nov. 5, 2014, incorporated herein by reference.

### BACKGROUND

1. Technical Field

The present invention generally relates to methods and systems for behavior query construction in temporal graphs. More particularly, the present disclosure is related to methods and systems for behavior query construction in temporal graphs using discriminative sub-trace mining.

2. Description of the Related Art

Because computer systems are widely deployed to manage businesses, ensuring the proper functioning of computer systems is an important aspect for the execution business. For example, if a system is compromised and/or encounters system failures, the security of the system cannot be guaranteed and/or the services hosted in the system may be interrupted. However, maintaining the proper functioning of computer systems is a challenging task, since system administrators have limited visibility into these complex systems.

Generally, it is difficult for system administrators to cope with vulnerabilities to computer systems, such as key-loggers, spyware, malware, etc., without monitoring and understanding system behaviors. System behaviors may include a set of information generated from when a system entity, such as a program, is executed to when the system entity is terminated, which is generally referred to as a path and/or execution trace. Execution traces of how system entities (e.g., processes, files, sockets, pipes, etc.) interact with each other at the operating system level may be collected when monitoring security-related behaviors.

However, monitoring a computer system generates huge amounts of data, typically stored in application logs that record all of the interactions among the system entities over time. For example, the logs include a sequence of events each of which describes at which time what kind of interactions happened between which system entities. Existing solutions require administrators to search among the application logs, which can be inefficient and ineffective, since some application logs (e.g., file access logs, firewall, network monitoring, etc.) provide only partial information about system behaviors.

Thus, better understanding of system behaviors and identification of potential system risks and malicious behaviors becomes a challenging task for system administrators due to the dynamics and heterogeneity of the system data.

### SUMMARY

In one embodiment of the present principles, a method for behavior query construction in temporal graphs using discriminative sub-trace mining is provided. In an embodiment, the method may include generating system data logs to provide temporal graphs, wherein the temporal graphs include a first temporal graph corresponding to a target behavior and a second temporal graph corresponding to a set of background behaviors, generating temporal graph patterns for each of the first and second temporal graphs to determine whether a pattern exists between a first temporal graph pattern and a second temporal graph pattern, wherein the pattern between the temporal graph patterns is a non-repetitive graph pattern, pruning the pattern between the first and second temporal graph patterns to provide a discriminative temporal graph, and generating behavior queries based on the discriminative temporal graph

In another embodiment, a system for behavior query construction in temporal graphs using discriminative sub-trace mining is provided. In an embodiment, the system may include a monitoring device to generate system data logs to provide temporal graphs, wherein the temporal graphs include at least a first temporal graph corresponding to a target behavior and a second temporal graph corresponding to a set of background behaviors, a temporal graph pattern generator to generate temporal graph patterns for each of the first and second temporal graphs, a pattern determiner to determine whether a pattern exists between a first temporal graph pattern and a second temporal graph pattern, wherein the pattern between the temporal graph patterns is a non-repetitive graph pattern, a pattern pruner, coupled to a bus, to prune the pattern between the first and second temporal graph patterns to provide at least one discriminative temporal graph, and a behavior query generator, coupled to the bus, to generate behavior queries based on the at least one discriminative temporal graph.

In yet another aspect of the present disclosure, a computer program product is provided that includes a computer readable storage medium having computer readable program code embodied therein for performing a method for behavior query construction in temporal graphs using discriminative sub-trace mining. In an embodiment, the method may include generating system data logs to provide temporal graphs, wherein the temporal graphs include a first temporal graph corresponding to a target behavior and a second temporal graph corresponding to a set of background behaviors, generating temporal graph patterns for each of the first and second temporal graphs to determine whether a pattern exists between a first temporal graph pattern and a second temporal graph pattern, wherein the pattern between the temporal graph patterns is a non-repetitive graph pattern, pruning the pattern between the first and second temporal graph patterns to provide a discriminative temporal graph, and generating behavior queries based on the discriminative temporal graph

These and other features and advantages will become apparent from the following detailed description of illustrative embodiments thereof, which is to be read in connection with the accompanying drawings.

### BRIEF DESCRIPTION OF DRAWINGS

The present principles will provide details in the following description of preferred embodiments with reference to the following figures wherein:

FIG. 1 is a block/flow diagram illustratively depicting an exemplary system/method for constructing behavior queries in temporal graphs using discriminative sub-trace mining, in accordance with an embodiment of the present principles;

FIG. 2 shows an illustrative example of temporal graphs, in accordance with an embodiment of the present principles;

FIG. 3 shows an exemplary a growth pattern, in accordance with an embodiment of the present principles;

FIG. 4A shows an exemplary a growth pattern, in accordance with an embodiment of the present principles;

FIG. 4B shows an exemplary a growth pattern, in accordance with an embodiment of the present principles;

FIG. 4C shows an exemplary a growth pattern, in accordance with an embodiment of the present principles;

FIG. 5 shows an exemplary residual graph, in accordance with an embodiment of the present principles;

FIG. 6 is a block/flow diagram illustratively depicting an exemplary system/method for pruning a pattern between temporal graph patterns, in accordance with an embodiment of the present principles;

FIG. 7 is a block/flow diagram illustratively depicting an exemplary system/method for pruning a pattern between temporal graph patterns, in accordance with an embodiment of the present principles;

FIG. 8 is an illustrative example of a sequence-based representation between temporal graph patterns, in accordance with the present principles;

FIG. 9 shows an exemplary processing system/method to which the present principles may be applied, in accordance with an embodiment of the present principles; and

FIG. 10 shows an exemplary processing system/method for constructing behavior queries in temporal graphs using discriminative sub-trace mining, in accordance with an embodiment of the present principles.

### DETAILED DESCRIPTION OF PREFERRED EMBODIMENTS

Methods and systems for behavior query construction in temporal graphs using discriminative sub-trace mining are provided. One challenge in monitoring and understanding system behaviors in computer systems to identify potential system risks using behavior queries is the heterogeneity and overall amount of the system data. According to one aspect of the present principles, the methods, systems and computer program products disclosed herein employ discriminative sub-trace mining to temporal graphs to mine discriminative sub-traces as graph patterns of security-related behaviors and construct behavior queries that are mapped to user-understandable semantic meanings and are effective for searching the execution traces. Security-related behaviors may include, but are not limited to, file compression/decompression, source code compilation, file download/upload, remote login, and system software management (e.g., installation and/or update of software applications). In addition, the instant methods and systems prune graph patterns that share similar growth trends, thereby significantly reducing computation time and increasing data storage efficiency, since repetitive searches are avoided and/or redundant searches are pruned without compromising pattern quality.

To ensure the security of a computer system enterprise, a system administrator may query system data logs to determine if a particular security behavior has occurred, such as activity over weekend when typically activity on the system is fairly limited. For illustrative purposes, activities may include remote access to the system, compression of several files, and/or transfer of the files to a remote server. Generally, the system administrator may be required to submit three separate queries (e.g., remote access login, compression of files, and transfer to remote server) and perform a search over the entire system data log to find a security related activity. In some instances, it may be difficult for system administrators to directly query such monitoring data, represented as temporal graphs, for security-related behaviors, referred to as behavior queries, since temporal graphs are complex with many tedious low-level entities (e.g., processes, files, etc.) recorded in the system data logs that cannot be directly mapped to any high-level activity (e.g., remote access login, compression of files, and transfer to remote server). In such instances, a semantic gap exists between such system-level interactions and the security-related behaviors of interest. To locate high-level activities, a system administrator must know which processes or files are involved in the high-level activity and in what order over time the low-level entities are involved in the high-level activity in order to write a query. However, due to the complexity of such temporal graphs, it becomes time-consuming for system administrators to manually formulate useful queries in order to examine abnormal activities, attacks, and vulnerabilities in computer systems.

To overcome this problem, the present principles teaches identifying the most discriminative patterns for target behaviors in temporal graphs and employ the most discriminative patterns as behavior queries. Accordingly, these behavior queries, which may consist of only a few edges, are easier to interpret and modify as well as being robust to noise. In accordance with one embodiment, a positive set and a negative set of temporal graphs may be determined, and temporal graph patterns with maximum discriminative score may be identified, as will be described in further detail below. Accordingly, a discriminative pattern should frequently occur in target behaviors and rarely exist in other behaviors.

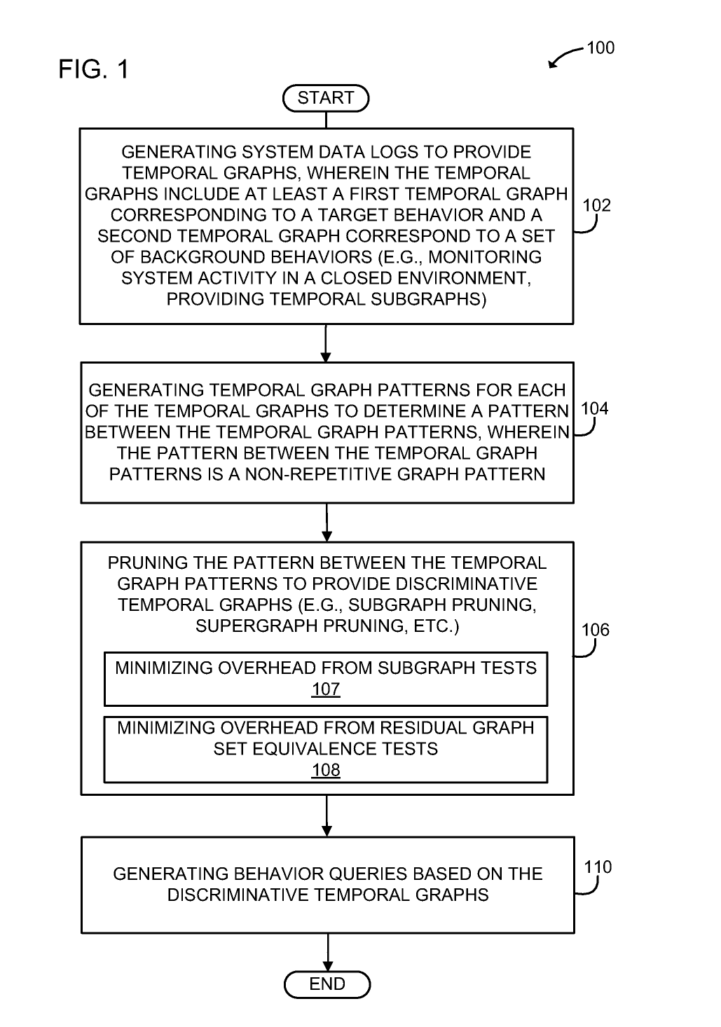

Referring to the drawings in which like numerals represent the same or similar elements and initially to FIG. 1, FIG. 1 shows a block/flow diagram illustratively depicting exemplary methods/systems 100 for constructing behavior queries in temporal graphs using discriminative sub-trace mining according to one embodiment of the present principles is shown.

Generally, pattern mining may characterize large and complex data sets into concise forms. Discriminative graph pattern mining is a feature selection method that may be applied in graph classification tasks to distinguish characteristics and identify differences between data sets. Specifically, discriminative pattern mining is a technique concerned with identifying a set of patterns and the frequency of those patterns that occur in data sets. According to one embodiment, discriminative pattern mining on temporal graphs may be implemented to identify patterns related to security-related behaviors in computer systems.

In block 102, the method 100 may include monitoring system data (e.g., execution of behavior traces at a computer system) and generating system data logs. System data logs, which may include raw system behaviors, target behaviors and/or background behaviors, may be collected and may be employed as input data. The system data logs may include information relating to how system entities interact with each other at the operating system (e.g. execution and/or behavior traces) and may include timestamps. In some embodiments, processes may be monitored and/or collected along with any corresponding files and/or timestamps. The processes, files and/or timestamps may be collected and/or generate a system data log and may be used to generate corresponding temporal graphs.

In one embodiment, the system data logs may be generated in a closed environment where only one target behavior is performed. For example, the system data logs include a target behavior that is independently run without other behaviors (e.g., background behaviors) running concurrently. In addition, the system data logs may include background behaviors independently run without the target behavior running concurrently.

In one embodiment, the system data logs may be modeled and/or be provided as temporal graphs corresponding to the system data logs, with nodes being system entities and edges being their interactions with timestamps. In an embodiment, the temporal graphs may include at least a first temporal graph corresponding to a target behavior and a second temporal graph corresponding to a set of background behaviors, as shown in block 102. Accordingly, the system data of a target behavior may generate a temporal graph of no more than a few thousand of nodes and/or edges. In addition, the system data of a set of background behaviors may generate a temporal graph comprising nodes and/or edges.

Temporal graphs are a graph representation of a set of objects where some pairs of objects, referred to as nodes, are connected by links and are referred to as edges. Generally, a temporal graph G is represented by a tuple (V,E,A,T), where V is a set of nodes, E⊂V×V×T is a set of directed edges that are totally ordered by their timestamps, A:V→Σ is a function that assigns labels to nodes (Σ is a set of node labels), and T is a set of possible timestamps, non-negative integers on edges. In some embodiments, the method employs temporal graphs with total edge order. In temporal graphs, edges may have timestamps. Therefore, edges may be ranked and/or ordered by the timestamps. If edges have a total order, then for any edges e₁ and e₂, either e₁'s timestamp may be smaller than e₂'s timestamp, or e₁'s timestamp may be greater than e₂'s timestamp. In other words, when temporal graphs include total edge order, no two edges share an identical timestamp. It should be noted that the present principles may be applied to temporal graphs with multi-edges, node labels and edge timestamps, as well as edge labels.

In an embodiment, the system data logs for a target behavior may include a set of positive temporal graphs and the system data logs for background behaviors may include a set of negative temporal graphs. For example, in block 102, the system data logs that include a target behavior may be treated as a set of positive temporal graphs, Gₚ, and the system data logs that include background behaviors may be treated as a set of negative temporal graphs, Gₙ. It should be noted that system data logs for normal and/or abnormal behaviors (e.g., intrusion behaviors) may be used as positive datasets, which may be employed to generate graph pattern queries for normal and/or abnormal behaviors.

In a further embodiment, the temporal graphs may include temporal subgraphs. Accordingly, the temporal subgraphs may include at least a first temporal subgraph corresponding to a target behavior and a second temporal subgraph corresponding to a set of background behaviors, as shown in block 102. For example, in some embodiments, it may advantageous and efficient to use discriminative subgraphs (hereinafter “subgraph”) of the temporal graphs to capture the footprint of a target behavior instead of employing the entire raw temporal graph from the system data logs as a behavior query.

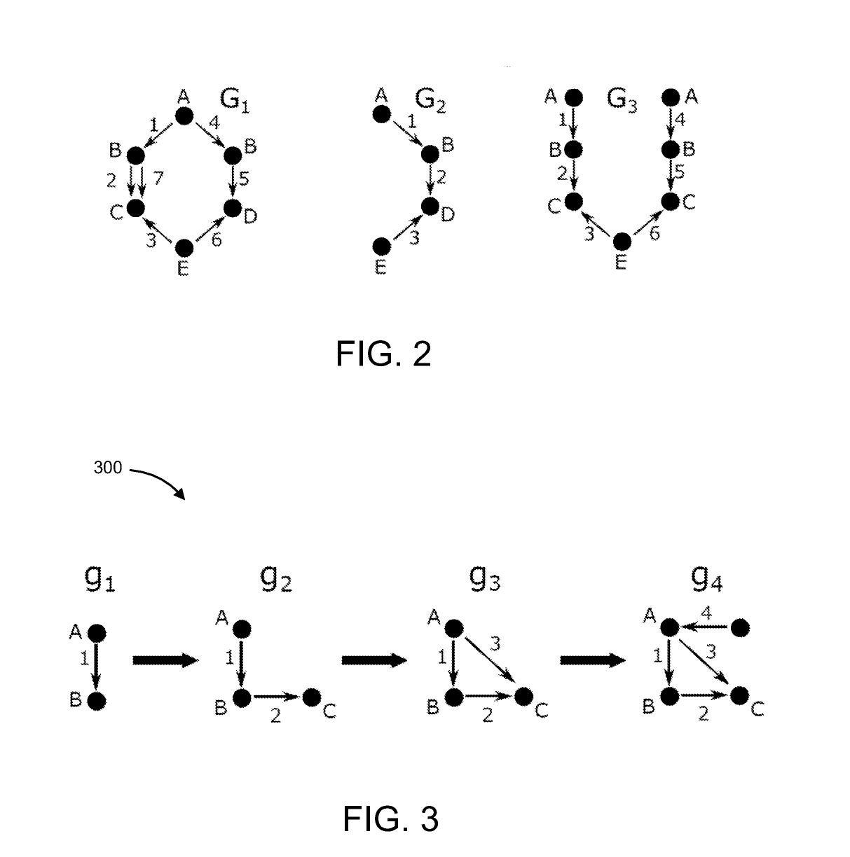

Given two temporal graphs, namely G=(V,E,A,T) and G′=(V′,E′,A′,T′), temporal graph G is a subgraph of G′ (e.g., G⊂^{t}G′) if and only if there exists two injective functions, such as f:V→V′ and τ:T→T′, such that node mapping, edge mapping, and edge order are preserved. Node mapping may be defined as ∀u∈V, A(u)=A′(f(u)), where V is the set of nodes in a temporal graph G, u is a node in temporal graph G, and f(u) is the node in G′ which u maps to, such that u and f(u) share an identical node label. Edge mapping may be defined as ∀(u,v,t)∈E,(f(u),f(v),τ(t))∈E′, where E is the set of edges in temporal graph G, (u,v,t) is an edge in G between node u and node v with timestamp t, E′ is the set of edges in G′, and (f(u),f(v),τ(t)) is an edge in G′ between node f(u) and node f(v) with timestamp 20. Accordingly, (u,v,t) maps to (f(u),f(v),τ(t)), where node u, node v, and timestamp t in temporal graph G map to node f(u), node f(v), and timestamp τ(t) in graph G′, respectively. Edge order may be defined as ∀(u₁,v₁,t₁),(u₂,v₂,t₂)∈E, sign(t₁−t₂)=sign(τ(t₁)−τ(t₂)), such that timestamp t₁ and t₂ in G map to timestamp τ(t₁) and τ(t₂) in G′, respectively. Thus, sign(t₁−t₂)=sign(τ(t₁)−τ(t₂)) means (1) if t₁ is smaller than t₂ (e.g., the sign of t₁−t₂ is negative), then τ(t) is smaller than τ(t₂) (e.g., the sign of τ(t₁)−(t₂) is negative); and (2) if t₁ is greater than t₂ (e.g., the sign of t₁−t₂ is positive), then τ(t₁) is greater than r(t₂) (e.g., the sign of τ(t₁)−(t₂) is positive). Temporal graph G′ is a match of temporal graph G, which may be denoted as G′=ₜG, when f and τ are bijective functions, where every element of one set is paired with one element of the other set, and every element of the other set is paired with one element of the first set such that there are no unpaired elements. An illustrative example of temporal subgraphs are illustratively shown in FIG. 2, which will be described in further detail below.

In block 104, the method may include generating temporal graph patterns for each of the first and second temporal graphs to determine whether a pattern exits between the first and second temporal graph patterns. In one embodiment, the pattern between the first and second temporal graph patterns is a non-repetitive graph pattern, as will be described in further detail below. A temporal graph pattern g=(V,E,A,T) is a temporal graph pattern where all of timestamps between the edges are between one (1) and the total amount of edges in the temporal graph, such that ∀t∈T, 1≦t≦|E|. Unlike general temporal graphs, where timestamps could be arbitrary non-negative integers, timestamps in temporal graph patterns are aligned (e.g., from 1 to |E|) and only total edge order is kept.

In an embodiment, the temporal graph patterns, such as the temporal graph patterns for each of the first and second temporal graphs, may be T-connected graph patterns. Temporal graphs may be differentiated between T-connected temporal graphs and non T-connected temporal graphs by distinguishing the type of connections between the temporal graphs. A temporal graph G=(V,E,A,T) is defined as T-connected if ∀(u,v,t)∈E where G is a temporal graph, V is the set of nodes in G, E is the set of edges in G, A is a function that assigns labels to nodes in G, and T is a function that assigns timestamps to edges in G. Thus, a temporal graph G is T-connected if (u, v, t), which is an edge in G between node u and node v with timestamp t, such that the edges whose timestamps are smaller than t form a connected graph. An illustrative example of T-connected temporal graphs and non T-connected temporal graphs are illustratively shown in FIG. 2, which will be described in further detail below.

With continued reference to FIG. 1, the method includes determining if a pattern is formed between the temporal graph patterns, as shown in block 104. In an embodiment, a determination is made whether or not a pattern exists between a first temporal graph pattern and a second temporal graph pattern corresponding to the first and second temporal graphs, respectively. In a preferred embodiment, the pattern is a non-repetitive graph pattern.

In one embodiment, a pattern is determined when each edge in a first temporal graph pattern corresponds to each edge in a second temporal graph pattern such that the node mappings between each edge are one-to-one. For example, assuming that a first temporal graph pattern g₁=(V₁,E₁,A₁,T₁), and a second temporal graph pattern g₂=(V₂,E₂,A₂,T₂), |V₁|=|V₂|, and a total amount of edges in the first temporal graph pattern is equal to a total amount of edges in the second temporal graph pattern, such that |E₁|=|E₂|, a linear scan may be conducted over edges in g₁. For each edge (u₁,v₁,t)∈E₁ in the first temporal graph pattern, an edge is located in the second temporal graph pattern, such as the edge (u₂,v₂,t)∈E₂. If such an edge exists, the mapping from u₁ to u₂ and the mapping from v₁ to v₂ is verified to ensure that such mappings are one-to-one. If both are, then (u₁,v₁,t) matches (u₂,v₂,t)∈E₂. Accordingly, a pattern between the first temporal graph pattern and the second temporal graph pattern exists (e.g., g₁=ₜg₂) when all the edges in g₁ find their matches in g₂. If two bijective functions are found, for example, f:V₁→V₂ and τ:T₁→T₂, the linear scan follows the unique way to match edge timestamps between g₁ and g₂ and |E₁|=|E₂|, τ is found and bijective. Accordingly, the present principles guarantees the node mapping f is one-to-one and, moreover, a full mapping of f is generated because |E₁|=|E₂| and all the nodes in g₁ and g₂ are mapped.

In one embodiment, at least two temporal graph patterns are determined whether or not they are identical in linear time. It should be noted that pattern growth is more efficient in temporal graphs compared with non-temporal graphs. For example, the computation advantages of temporal graphs originate from the following property. Assuming that g₁ and g₂ are temporal graph patterns, if g₁=ₜg₂, the mappings f and τ between them are unique. This is referred to herein as Lemma 1. It may be assumed that g₁=(V₁,E₁,A₁,T₁) and g₂=(V₂,E₂,A₂,T₂). Since g₁ and g₂ are temporal graph patterns, we have ∀(u₁,v₁,t₁)∈E₁, 1≦t₁≦|E₁| and ∀(u₂,v₂,t₂)∈E₂, 1≦t₂≦|E₂|. Because g₁=ₜg₂ and |E₁|=|E₂|, (u₁,v₁,t₁)∈E₁ matches (u₂,v₂,t₂)∈E₂ only if t₁=t₂ in order to preserve total edge order. Thus, the uniqueness of τ is proved such that τ:T₁→T₂. Since τ is unique, the edge mapping between g₁ and g₂ is unique, and therefore the node mapping f is also unique such that f:V₁→V₂.

In addition, it is costly to conduct pattern growth for non-temporal graphs. To grow a non-temporal pattern to a specific larger one, a combination of different ways may be employed. However, in order to avoid repeated computation, additional computations are needed to confirm whether one pattern is a new pattern or is an already discovered one. Accordingly, this results in high computation cost, as graph isomorphism is inevitably involved. To reduce the overhead, various canonical labeling techniques along with their sophisticated pattern growth algorithms have been proposed, but the cost is still very high because of the intrinsic complexity in graph isomorphism. Unlike mining non-temporal graphs, the present principles avoids repeated pattern search without using any sophisticated canonical labeling or complex pattern growth algorithms.

In one embodiment, the pattern may include a consecutive growth pattern. For example, a consecutive graph pattern exists when a pattern between temporal graph patterns guides the search in pattern space and conducts a depth-first search, starting with an empty pattern, growing the empty pattern into a one-edge pattern, and exploring all possible patterns in its branch. When one branch is completely searched, additional branches initiated by other one-edge patterns may be searched. Advantageously, the present principles enable efficient pattern growth without repetition as well as providing all possible connected temporal graph patterns. In addition, consecutive growth patterns guarantee that a connected temporal graph pattern will form another connected temporal graph pattern without repetition. In an embodiment, a pattern is a consecutive growth pattern when, given a connected temporal graph pattern g of edge set E and an edge e′=(u′,v′,t′), edge e′ is added into g and another connected temporal graph pattern and t′=|E|+1 results. An illustrative example of a consecutive growth pattern is illustratively shown in FIG. 3, which will be described in further detail below. In a further embodiment, the consecutive growth pattern may include at least one of a forward growth pattern, a backward growth pattern, or an inward growth pattern, which will be described in further detail below.

With continued reference to FIG. 1, after the pattern between the temporal graph patterns is determined, the method includes pruning the pattern to provide at least one discriminative temporal graph, as shown in block 106. In one embodiment, the patterns are pruned to select only those sub-relations with maximum frequency and/or maximum discriminative score. For any temporal graph pattern g, its discriminative score may be evaluated by a discriminative function F, which returns a real value for g as its discriminative score. Among all possible patterns, the patterns with the largest discriminative score have the maximum discriminative score. In a further embodiment, pruning includes pruning temporal sub-relations, including subgraph pruning and/or supergraph pruning, which will be described in further detail below.

In some embodiments, given a set of temporal graphs G and a temporal graph pattern g, the frequency of the temporal graph pattern g with respect to G may be defined as:

$$freq ( G , g ) = \frac{\vert \{ G \vert g {⊆}_{I} G ⋀ G ∈ G \} \vert}{\vert G \vert} .$$

According to the present principles, a set of positive temporal graphs, Gₚ, and a set of negative temporal graphs, Gₙ, may be generated to find the connected temporal graph patterns g″ with maximum discriminative score F(freq(Gₚ,g*),freq(Gₙ,g*)), where F(x,y) is a discriminative score function with partial anti-monotonicity, such that (1) when x is fixed, y is smaller, then F(x,y) is larger, and (2) when y is fixed, x is larger, then F(x,y) is larger. F(x,y) is a discriminative function with two variables x and y, where x is freq(Gₚ,g) (e.g., the frequency of temporal graph pattern g in the positive graph set Gₚ) and y is freq(Gₙ,g) (e.g., the frequency of pattern g in the negative graph set Gₙ). It should be noted that F(x,y) may include score functions, such as, for example, G-test, information gain, etc. In a preferred embodiment, a discriminative score function that satisfies partial anti-monotonicity and best fits query formulation task may be selected. It should also be noted that the discriminative score of a temporal graph pattern g is denoted as F(g).

In one embodiment, the set of positive temporal graphs Gₚ and the set of negative temporal graphs Gₙ may be employed to determine the most discriminative temporal graph patterns in the system data logs. In a further embodiment, once the discriminative temporal graph patterns are determined, the discriminative temporal graph patterns may be ranked by domain knowledge, including semantic/security implication on node labels and node label popularity among monitoring data, to identify the patterns that best serve the purpose of behavior search.

A search algorithm may include a pruning condition, such as consideration of an upper bound of a pattern's discriminative score. Given a temporal graph pattern g, the upper bound of g indicates the largest possible discriminative score that could be achieved by g's supergraphs. Letting Gₚ and G be a positive graph set and a negative graph set, respectively, the upper bound may be F(freq(Gₚ,g′), freq(Gₙ,g′))≦F(freq(Gₚ,g),0), since ∀g⊂ₜg′, freq(Gₚ,g′)≦freq(Gₚ,g) and freq(Gₙ,g′)≧0. While the upper bound is theoretically tight, it may be ineffective for pruning in practice.

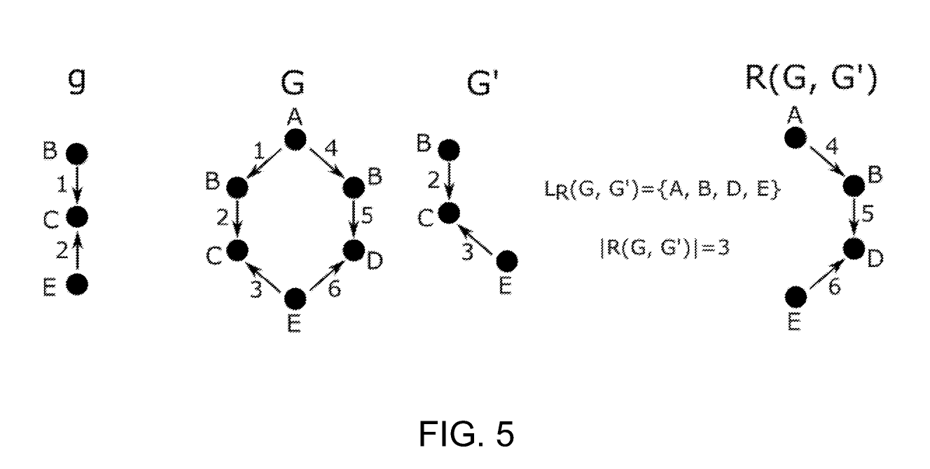

In an embodiment, pruning the pattern between the temporal graph patterns may include determining a set of residual graphs for each temporal graph pattern. For example, if G′ is a subgraph of G, the edges in G whose timestamps are less than the largest edge timestamp in G′ may be removed to form a residual graph. Given a temporal graph G=(V,E,A,T) and its subgraph G′=(V′,E′,A′,T′), R(G,G′)=(V_{R},E_{R},A_{R},T_{R}) is G's residual graph with respect to G′, where (1) E_{R}⊂E satisfies ∀(u₁,v₁,t₁)∈E_{R}, (u₂,v₂,t₂)∈E′, t₁>t₂, and (2) V_{R} is the set of nodes that are associated with edges in E_{R}. The size of the residual graph R(G,G′) may be defined as |R(G,G′)|=|E_{R}| (e.g., the number of edges in R(G,G′)). Accordingly, a residual graph's R(G,G′) residual node label set may be defined as L_{R}(G,G′)={A_{R}(u)|∀u∈V_{R}}. An illustrative example of a temporal graph pattern g, a temporal graph G, a temporal subgraph G′, a residual graph R(G,G′), and a residual node label set L_{R}(G,G′)={A_{R}(u)|∀u∈V_{R}} is illustratively shown in FIG. 5, which will be described in further detail below.

Accordingly, M(G,g) may represent a set including all the subgraphs in G that match a temporal graph pattern g. Given Gₚ and g, a positive residual graph set R(Gₚ,g) may be defined as:

$$R ( {G}_{p} , g ) = {⋃}_{G ∈ {G}_{p}} \{ R ( G , {G}^{′} \vert {G}^{′} ∈ M ( G , g ) \} .$$

Given R(Gₚ,g), its residual node label set L(Gₚ,g) may then be defined as:

$$L ( {G}_{p} , g ) = {⋃}_{G ∈ {G}_{p}} {⋃}_{{G}^{′} ∈ M ( G , g )} {L}_{R} ( G , {G}^{′} ) .$$

Similarly, a negative residual graph set R(Gₙ,g) and its residual node label set L(Gₙ,g) may be defined. Accordingly, given a temporal graph set G and two temporal graph patterns g₁⊂ₜg₂, if R(G,g₁)=R(G,g₂), then the node mapping between g₁ and g₂ is unique.

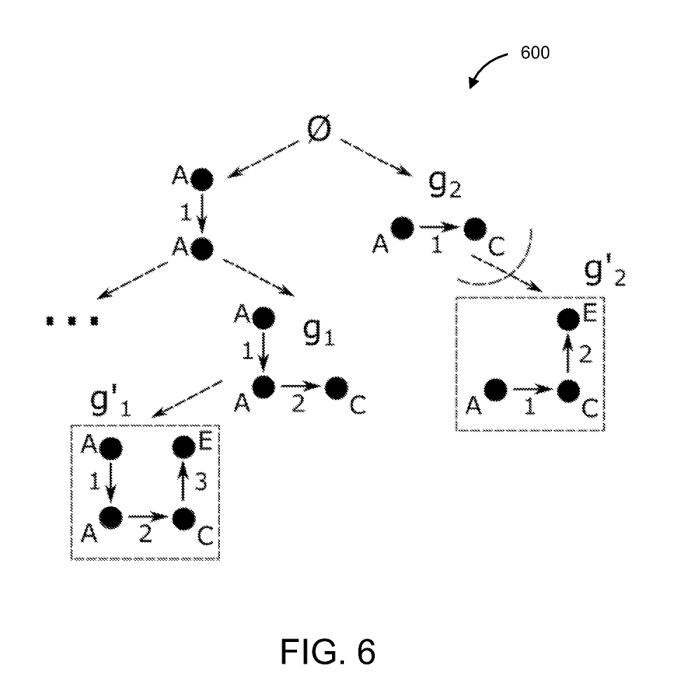

In one embodiment, pruning the temporal graph patterns in block 106 may include subgraph pruning. It should be noted that, for a temporal graph pattern g, g's branch may be employed to refer to the space of patterns that are grown from g, and F* denotes the largest discriminative score discovered. In subgraph pruning, g₁ and g₂ represent temporal graph patterns where g₁ is discovered before g₂. If g₂ is a temporal subgraph of g₁, and g₁ and g₂ share identical positive residual graph sets, and for those nodes in g₁ that cannot match to any nodes in g₂, their labels never appear in g₂'s residual node label set, subgraph pruning on g₂ may be performed. Given a discovered pattern g₁=(V₁,E₁,A₁,T₁) and a pattern g₂ of node set V₂, if (1) g₂⊂g₁, (2) R(Gₚ,g₂)=R(Gₚ,g₁), and (3) L(Gₚ,g₂)∩L_{g}_{₁}_{\g}_{₂}=φ, where φ is the empty set and L_{g}_{₁}_{\g}_{₂}={A₁(u)|∀u∈V₁\V₁′} and V₁′⊂V₁ is the set of nodes that map to nodes in V₂, then the search on g₂'s branch may be pruned, if the largest discriminative score for patterns in g₁'s branch is smaller than F*. An illustrative example of subgraph pruning is illustratively shown in FIG. 6, which will be described in further detail below.

Accordingly, subgraph pruning prunes pattern space without missing any of the most discriminative patterns. This may be referred to as Lemma 4. To prove this lemma, g₁ and g₂ are temporal graph patterns, where g₁ is discovered before g₂, and it is assumed that g₁ and g₂ satisfy the conditions in subgraph pruning. Since the conditions in subgraph pruning are satisfied, the following facts may be derived: (1) freq(Gₚ,g₂)=freq(Gₚ,g₁) and (2) pattern growth in g₁'s branch will never touch the nodes that cannot map to any nodes in g₂ as L(Gₚ,g₂)∩L_{g}_{₁}_{\g}_{₂}=φ. Assume there exists a pattern g₂′ whose discriminative score is no less than F* and s is the sequence of consecutive growth that grows g₂ into g₂′. Since no pattern growth in g₁'s branch will touch the nodes that cannot map to any nodes in g₂, s then indicates a valid sequence of consecutive growth (with some timestamp shift) that grows g₁ into g₁′.

By freq(Gₚ,g₂)=freq(Gₚ,g₁) and R(Gₚ,g₂)=R(Gₚ,g₁), it may be inferred that freq(Gₚ,g₂′)=freq(Gₚ,g₁′). Accordingly, g₂′⊂ₜg₁′ and freq(Gₙ,g₂′)≧freq(Gₙ,g₁′), and it may be inferred that F(g₂′)≦F(g₁′), meaning that g₁′ is one of the most discriminative patterns which contradicts with the condition that none of the patterns in g₁'s branch is the most discriminative. Thus, none of the patterns in g₂'s branch will be the most discriminative, if the conditions in subgraph pruning are satisfied, and none of the patterns in g₁'s branch is the most discriminative. Therefore, we can claim any patterns in g₂'s branch will have discriminative score less than F*, and the branch can be safely pruned.

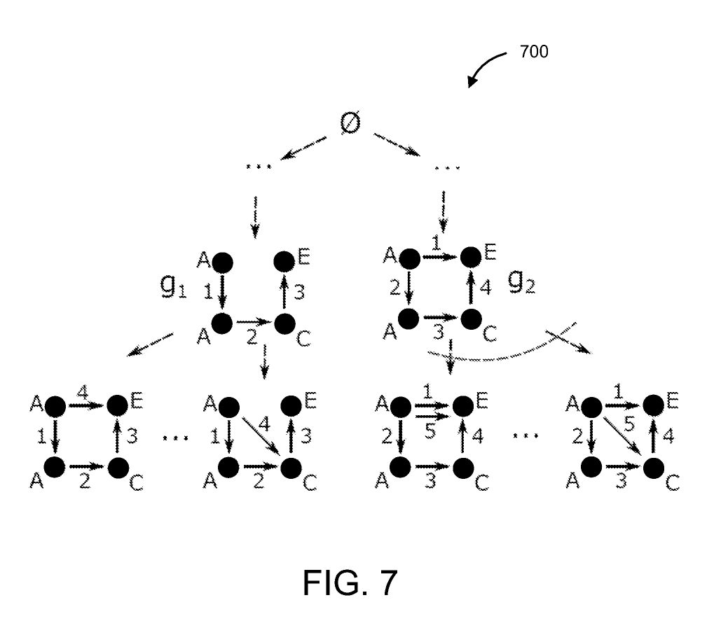

In one embodiment, pruning the temporal graph patterns in block 106 may include supergraph pruning. In supergraph pruning, g₁ and g₂ represent temporal graph patterns where g₁ is discovered before g₂. If g₁ is a temporal subgraph of g₂, and g₁ and g₂ share identical positive residual graph sets, and g₁ and g₂ have the same number of nodes, then supergraph pruning on g₂ may be performed. Given two patterns g₁ and g₂, where g₁ is discovered before g₂ and g₂ is not grown from g₁, if (1) g₂⊃ₜg₁, (2) R(Gₚ,g₂)=R(Gₚ,g₁), (3) R(Gₙ,g₂)=R(Gₙ,g₁), and (4) g₂ and g₁ have the same number of nodes, the search in g₂'s branch may be safely pruned, if the largest discriminative score for g₁'s branch is smaller than F*. An illustrative example of supergraph pruning is illustratively shown in FIG. 7, which will be described in further detail below.

Accordingly, supergraph pruning prunes pattern space without missing the most discriminative patterns. This may be referred to as Proposition 2. Lemma 4 and Proposition 2 may lead to the following theorem, namely, that performing subgraph pruning and supergraph pruning guarantees the most discriminative patterns will still be preserved.

This theorem identifies general cases pruning may be conducted in temporal graph space. In some embodiments, however, it may be advantageous to conduct either subgraph pruning and/or supergraph pruning when the overhead for discovering these pruning opportunities is small. The major overhead of subgraph pruning and supergraph pruning may come from two sources: (1) temporal subgraph tests (e.g., g₂⊂ₜg₁), and (2) residual graph set equivalence tests (e.g., R(Gₚ,g₂=R(Gₚ,g₁)). Accordingly, the method 200 may further include minimizing this overhead.

With continued reference to FIG. 1, in block 106, the method 100 may include minimizing overhead from subgraph tests, as shown in block 107, and minimizing overhead from residual graph set equivalence tests, as shown in block 108. In some embodiments, when pruning is at least one of subgraph pruning and/or supergraph pruning, the method may include either one or both of blocks 107 and 108.

In block 107, the method 100 may include minimizing overhead from subgraph tests. In an embodiment, minimizing overhead from subgraph tests may include representing temporal graphs by sequences using an encoding scheme and employing a light-weight algorithm based on subsequence tests. Given two temporal graphs g and g′, it is NP-complete to decide g⊂ₜg′. Since edges are totally ordered in temporal graphs, temporal graphs may be encoded into sequences. In addition, after temporal graphs are represented as sequences, a faster temporal subgraph test may be employed using efficient subsequence tests.

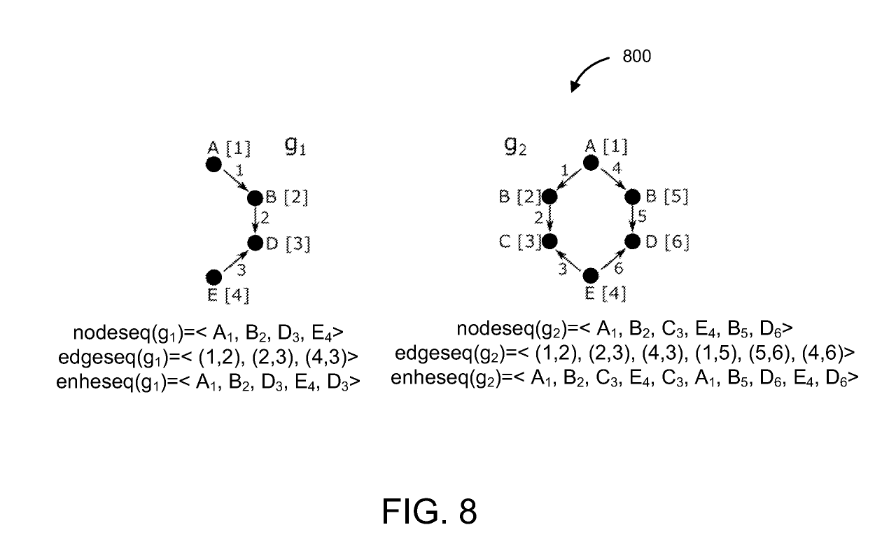

A temporal graph pattern g may be represented by two sequences, namely a node sequence and an edge sequence. A node sequence, nodeseq(g) is a sequence of labeled nodes. Given g is traversed by its edge temporal order, nodes in nodeseq(g) may be ordered by their first visited time. Any node of g may appear only once in nodeseq(g). An edge sequence, edgeseq(g), is a sequence of edges in g, where edges are ordered by their timestamps. A sequence may be defined as s, such that s₁=(a₁,a₂, . . . , aₙ) and s₂=(b₁,b₂, . . . , bₘ) are two sequences, where a is an element in the sequence s₁ (where aᵢ is the i-th element in the sequence s₁), b is an element in the sequence s₂ (where bᵢ is the i-th element in the sequence s₂), n is the total number of elements in the sequence s₁, and m is the total number of elements in the sequence s₂. If there exists 1≦i₁<i₂< . . . <iₙ≦m such that ∀1≦j≦n, aⱼ=bᵢ_{ⱼ}, then s₁ is a subsequence of s₂, denoted as s₁⊂s₂. It should be noted that i₁, i₂, . . . , iₙ are n integer variables in the range between 1 and m and j is an integer variable in the range between 1 and n. For example, if n=5, m=7, then s₁ is a sequence of five elements as s₁=(a₁,a₂,a₃,a₄,a₅) and s₂ is a sequence of seven elements as s₂=(b₁,b₂,b₃,b₄,b₅,b₆,b₇). In this case, i₁, i₂, . . . , i₅ are five integer variables that are no smaller than 1 and no greater than 7. In terms of mapping, j maps to iⱼ (e.g., j=2 maps to i₂ so that a₂ maps bᵢ₂). An illustrative example of sequence-based temporal graph representation and temporal subgraph test is illustratively shown in FIG. 8, which will be described in further detail below.

In an embodiment, the minimizing overhead from subgraph tests includes providing an enhanced node sequence of a temporal graph, enhseq(g). This is because, given two temporal graphs g₁ and g₂, if g₁⊂ₜg₂, nodeseq(g₁)⊂nodeseq(g₂). Accordingly, if g is a temporal graph, enhseq(g) is a sequence of labeled nodes in g. Given that temporal graph pattern g is traversed by its edge temporal order, enhseq(g) may be constructed by processing each edge (u,v,t) as follows. (1) If u is the last added node in the current enhseq(g), or u is the source node of the last processed edge, u may be skipped; otherwise, u will be added into the enhseq(g). (2) Node v may be always added into enhseq(g). It should be noted that nodes in g might appear multiple times in enhseq(g).

Accordingly, two temporal graphs g₁⊂ₜg₂ if and only if:

nodeseq(g₁)⊂edgeseq(g₂), where the underlying match forms an injective node mapping fₛ from nodes in g₁ to nodes in g₂; and

fₛ(edgeseq(g₁))⊂edgeseq(g₂) where fₛ(edgeseq(g₁)) is an edge sequence where the nodes in g₁ are replaced by the nodes in g₂ via the node mapping fₛ. This may be referred to as Lemma 5.

In block 108, the method 100 may include minimizing overhead from residual graph set equivalence tests. In an embodiment, g₁ and g₂ represent temporal graph patterns. Accordingly, G₁′ and G₂′ may be the matches of temporal graph patterns g₁ and g₂ in temporal graph G, respectively. Since edges in temporal graphs have total order, the following result may be derived: the residual graph R(G,G₁′) is equivalent to the residual graph R(G,G₂′) if and only if the size of the residual graph for G₁′ and G₂′ are the same, e.g., |R(G,G₁′)|=|R(G,G₂′)|. Thus, given temporal graph patterns g₁ and g₂ with g₁⊂g₂, and a set of graphs G, residual graphs R(G,g₁)=R(G,g₂) if and only if I(G,g₁)=I(G,g₂), where

$$I ( G , {g}_{i} ) {\sum }_{R ( G , {G}^{′} ) ∈ r ( G , {g}_{i} )}^{ } \vert R ( G , {G}^{′} ) \vert .$$

This may be referred to as Lemma 6. R(G,G′) is a residual graph, and |R(G,G′)| is the size of R(G,G′), which is an integer. Therefore, I(G,gᵢ) is a function with two variables G and gᵢ, which returns an integer obtained by summing up the sizes of all residual graphs in the graph set R(G,gᵢ). Accordingly, overhead may be minimized by testing equivalent residual graph sets by leveraging temporal information in graphs.

Advantageously, pruning redundant searches of temporal graph patterns that share similar and/or identical growth trends minimizes overhead of temporal subgraph tests and residual graph set equivalence tests that are used for identifying pruning opportunities. In addition, pruning redundant searches of temporal graph patterns increases computation time and minimizes overhead during the mining process, since the underlying pattern space could be large and a typical naive search algorithm cannot scale.

In block 110, behavior queries based on the discriminative temporal graphs may be generated. In an embodiment, patterns with the highest discriminative score may be selected as queries to search target behavior activities from a repository of system data logs to determine if there are abnormal and/or suspicious activities occurring (e.g., too many times a target behavior occurs over a Saturday night). For example, the discriminative temporal graph may be used to construct behavior queries, and may subsequently be employed to query a computer system, such as system data logs, to determine if target behaviors have been performed. For example, the discriminative temporal graph may be used to form a graph query (e.g. a behavior query) to search the existence of a target behavior in collected system monitoring data. To search the existence of a target behavior in the system, the graph query may be used to perform a pattern search over the large temporal graph of the system data to find subgraphs of the large temporal graph that match the query. Each match may indicate one possible existence of the target behavior in the system. In an embodiment, the present principles may be applied to behavior queries with multiple behaviors. For example, for each target behavior, its discriminative pattern is determined to generate respective behavior queries, and the respective behavior queries are employed to search the system monitoring data for its existence (e.g. match). In another embodiment, the matches may be connected to form a behavior queries associated with the multiple behaviors. Advantageously, the present principles increase computation efficiency and reduce storage of such information, since repeated searches and/or patterns are pruned.

The method 100 provides an effective method for behavior analysis, with behavior queries having high precision (e.g., 97%) and high recall (e.g., 91%), which are better than non-temporal graph patterns whose precision and recall are 83% and 91%, respectively. Precision and recall are generally used as the metrics to evaluate the accuracy of the present principles. Given a target behavior and its behavior query, a match of this behavior query is called an identified instance. An identified instance is correct if the time interval during which the match happened is fully contained in a time interval during which one of the true behavior instances was under execution. A behavior instance is discovered if the behavior query can return at least one correct identified instance with respect to this behavior instance. Accordingly, precision is defined as the number of correctly identified instances divided by the total number of identified instances, and recall is defined as the number of discovered instances divided by the number of behavior instances. In addition to these advantages, the present principles provided herein are more efficient and enable fast pattern mining in temporal graphs than previous methods, typically providing pattern mining approximately thirty-two times faster than previously employed methods.

It should be noted that discriminative graph pattern mining dealing with non-temporal graphs require identical activities happening within the exact same time intervals. In addition, it is difficult to extend existing works that mine discriminative static graph patterns to handle temporal graphs, since their canonical labeling techniques cannot deal with temporal graphs which could have multiple edges between same pair of nodes and include temporal edge orders. Moreover, discriminative graph pattern mining dealing with non-temporal graphs do not discuss how to deal with timestamps in the mining process. If timestamps are ignored, multi-edges must be collapsed into a single edge, and the final result of the discriminative mining will be a partial result, as it excludes patterns with multi-edges. In addition, a redundancy in non-temporal patterns may bring potential scalability problems, as a large number of temporal patterns may share the same non-temporal patterns, and a discriminative non-temporal pattern may result in no discriminative temporal pattern.

Now referring to FIG. 2, several temporal graphs are shown for illustrative purposes. In an embodiment, it is preferable to use temporal graphs with total edge order. As shown in FIG. 2, temporal graph G₁ illustrates multi-edges as contemplated in the present invention. According to the present principles, temporal graphs that include node labels (e.g., A, B, C, D, E, etc.) and/or edge timestamps (e.g., 1, 2, 3, 4, 5, 6, 7, etc.) are contemplated in addition to temporal graphs with edge labels. In one embodiment, the timestamps in the temporal graph patterns may be aligned (e.g., from 1 to |E|) and, in some embodiments, only total edge order is kept, unlike general temporal graphs where timestamps could be arbitrary non-negative integers.

In FIG. 2, an example of a temporal subgraph is illustratively depicted, where G₂ is a temporal subgraph of G₁, namely G₂⊂^{t}G₁. In particular, the temporal subgraph in G₁, which may be formed by edges of the timestamps (e.g., 4, 5, and 6), is a match of G₂. With continued reference to FIG. 2, temporal graphs G₁ and G₂ are T-connected temporal graphs while temporal graph G₃ is not T-connected (e.g., non T-connected), since the graph formed by edges with timestamps smaller than five (e.g., 5) is disconnected. In a preferred embodiment, discriminative mining is employed with T-connected temporal graph patterns (hereinafter referred to as “connected temporal graphs”). In pattern growth, T-connected patterns remain connected, while non T-connected patterns might be disconnected during the growth process, resulting in formidable growth of pattern search space. In addition, any non T-connected temporal graph may be formed by a set of T-connected temporal graphs. In an embodiment, a single T-connected pattern or a set of T-connected patterns that include a non T-connected pattern may be used to form a behavior query.

Now referring to FIG. 3, an example of a consecutive growth pattern 300 for patterns of temporal graph patterns is illustrated for exemplary purposes. In FIG. 3, a consecutive growth pattern 300 may be determined when a temporal graph pattern g₁ is grown to temporal graph pattern g₄ by consecutive growth. In an embodiment, consecutive growth occurs when, given a connected temporal graph pattern g of edge set E and an edge e′=(u′,v′,t′), edge e′ is added into g and another connected temporal graph pattern and t′=|E|+1 results.

For example, assuming g₁ and g₂ are connected temporal graph patterns with g₁⊂g₂, a pattern is a consecutive growth pattern when there exists a unique way to grow g₁ into g₂. Alternatively, a pattern is not a consecutive growth pattern then there is no way to grow g₁ into g₂. This may be referred to herein as Lemma 3. If the edge sets of g₁ and g₂ are E₁ and E₂, respectively, m=|E₂|−|E₁| steps of consecutive growth may be conducted to grow g₁ into another pattern g₂′. If there exists g₂′=ₜg₂, then it may be possible to grow g₁ into g₂. Otherwise, there is no way to grow g₁ to g₂. If g₁ may be grown into g₂, then the m steps of consecutive growth is unique.

For example, assume that (1) s′= [symbol] e₁′,e₂′, . . . , eₘ′ [symbol] is a sequence of consecutive growth that grows g₁ into g₂′ with g₂′=ₜg₂, (2) s″= [symbol] e₁″,e₂″, . . . , eₘ [symbol] is another sequence of consecutive growth that grows g₁ into g₂″ with g₂″=ₜg₂, and (3) s′ is distinct from s″ as ∃(u′,v′,t′)∈s′ cannot match (u″,v″,t″)∈s″. Since g₂′=ₜg₂ and g₂″=ₜg₂, g₂′=ₜg₂″ may be inferred by the bijective mapping functions. By the definition of a consecutive growth pattern, the linear scan from Lemma 2 may decide g₂′ cannot match g₂″, since there exists at least one edge from s′ that cannot match the edge in s″ sharing the same timestamp, which contradicts with g₂′=ₜg₂″. Thus, s′ is identical to s″, and the m steps of consecutive growth is unique.

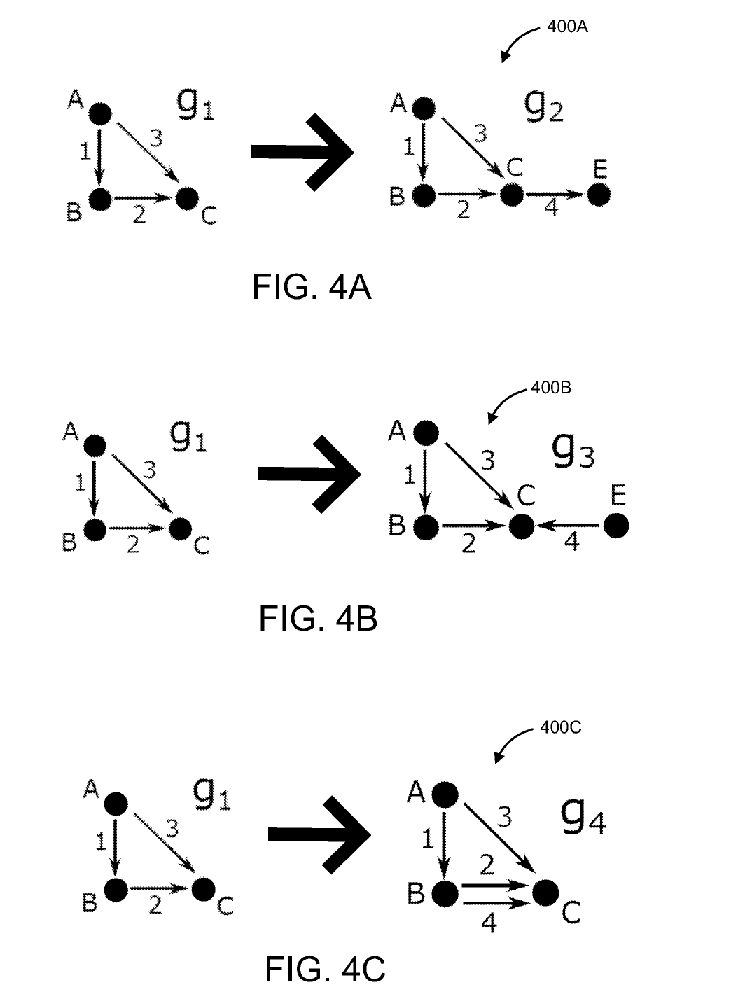

Now referring to FIGS. 4A-4C, the consecutive growth pattern may include at least one of a forward growth pattern, a backward growth pattern, or an inward growth pattern, which will be described in further detail below. FIG. 4A is an illustrative example of a forward growth pattern. FIG. 4B is an illustrative example of a backward growth pattern. FIG. 4C is an illustrative example of an inward growth pattern. Advantageously, the forward growth pattern, backward growth pattern and/or inward growth pattern enable the non-repetitive graph pattern to cover the whole pattern space to achieve completeness and guarantee the quality of discovered patterns.

For example, letting g be a connected temporal graph pattern with node set V, temporal graph pattern g may be grown by consecutive growth as follows. If the non-repetitive graph pattern includes a forward growth pattern 400A, as shown in FIG. 4A, then temporal graph pattern g may be grown by an edge (u,v,t) if u∈V and v∉V. If the non-repetitive graph pattern includes a backward growth pattern 400B, as shown in FIG. 4B, then temporal graph pattern g may be grown by an edge (u,v,t) if u∉V and v∈V. If the non-repetitive graph pattern includes an inward growth pattern 400C, as shown in FIG. 4C, then temporal graph pattern g may be grown by an edge (u,v,t) if u∈V and v∈V. It should be noted that the inward growth pattern 400C allows multi-edges between node pairs. Accordingly, the three growth patterns, namely forward 400A, backward 400B, and inward 400C, provide guidance to conduct a complete search over the pattern space.

For example, if A represents a search algorithm following consecutive growth with forward, backward, and inward growth patterns, algorithm A guarantees (1) a complete search over pattern space, and (2) no pattern will be searched more than once. This may be referred to herein as Theorem 1. Assuming temporal graph pattern g is a connected temporal graph pattern, Lemma 3 states that a consecutive growth pattern guarantees a unique way to grow an empty pattern into g to ensure that no pattern may be searched more than once. Thus, there is no way to search g more than once. For completeness over the pattern search, assume m is the number of edges in a temporal graph pattern. If the completeness holds for m=k, then it holds for m=k+1. Assuming the completeness holds for m=k, the complete set of k-edge connected temporal graph patterns H^{(k)} is determined. Further, if g^{(k+1)}=g^{(k)}∪{e} is a connected pattern of k+1 edges that is grown from a pattern g^{(k)} of k edges, and since the three growth patterns are all possible ways to keep patterns connected during growth, if g^{(k+1)} cannot be covered by growing patterns in H^{(k)}, it implies g^{(k)}∉H^{(k)}, that is, g^{(k)} is not connected, which contradicts with the assumption that g^{(k+1)} is connected (e.g., T-connected). Therefore, the completeness also holds for m=k+1.

Now referring to FIG. 5, an illustrative example of a temporal graph pattern g, a temporal graph G, a temporal subgraph G′, a residual graph R(G,G′), and a residual node label set L_{R} (G,G′)={A_{R} (u)|∀u∈V_{R}} is illustratively shown, in accordance with the present principles. As shown in FIG. 5, temporal graph G′ is a subgraph of temporal graph G, and R(G,G′) represents G's residual graph with respect to G′, and L_{R}(G,G′) is the residual graph's residual node set.

Now referring to FIG. 6, an illustrative example of a subgraph pruning 600 is illustratively depicted, in accordance with the present principles. In the mining process, a pattern g₂ may be determined and a discovered pattern g₁ may exist, which satisfies the conditions in subgraph pruning. Therefore, pattern growth in g₁'s branch suggests how to grow g₂ to larger patterns (e.g., growing g₁ to g₁′ indicates we can grow g₂ to g₂′). Since none of the patterns in g₁'s branch have the score F″, the patterns in g₂'s branch cannot be the most discriminative ones as well, which can be safely pruned (e.g., removed).

Now referring to FIG. 7, an illustrative example of a supergraph pruning 700 is illustratively depicted, in accordance with the present principles. In the mining process, a temporal graph pattern g₂ may be determined, and another pattern g₁ may be discovered before g₂, which satisfies the conditions in supergraph pruning. Therefore, the growth knowledge in g₁'s branch suggests how to grow g₂ to larger patterns. Since none of the patterns in g₁'s branch are the most discriminative, it may be inferred that the patterns in g₂'s branch are unpromising as well, and the search in g₂'s branch may be safely pruned (e.g., removed).

Now referring to FIG. 8, an illustrative example of a sequence-based representation 800 is illustratively depicted, in accordance with the present principles. In g₁ and g₂, node labels are represented by letters, and nodes of the same labels are differentiated by their node IDs represented by integers in brackets. Node labels in nodeseq are associated with node IDs as subscripts. It should be noted that when node labels are compared, their subscripts will be ignored (e.g., ∀i, j, Bᵢ=Bⱼ). Each edge in edgeseq is represented by the following format (id(u),id(v)), where id(u) is the source node ID and id(v) is the destination node ID.

Given two temporal graphs g₁ and g₂, if g₁⊂ₜg₂, it is expected that nodeseq(g₁)⊂nodeseq(g₂) and edgeseq(g₁)⊂edgeseq(g₂). However, when g₁⊂ₜg₂, nodeseq(g₁)⊂nodeseq(g₂) may not be true, as shown in FIG. 8, because the first visited time of the node with label E is inconsistent in g₁ and g₂. In an embodiment, as described above, enhanced node sequences of g₁ and g₂ may be provided. As shown in FIG. 8, g₁ and g₂ are two temporal graphs satisfying g₁⊂ₜg₂. The node sequence of g₁ is a subsequence of the enhanced node sequence of g₂ with the injective node mapping fₛ(1)=1, fₛ(2)=5, fₛ(3)=6, and fₛ(4)=4 to obtain fₛ(edgeseq(g₁))= [symbol] (1,5), (5,6),(4,6) [symbol] such that fₛ(edgeseq(g₁))⊂edgeseq(g₂).

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

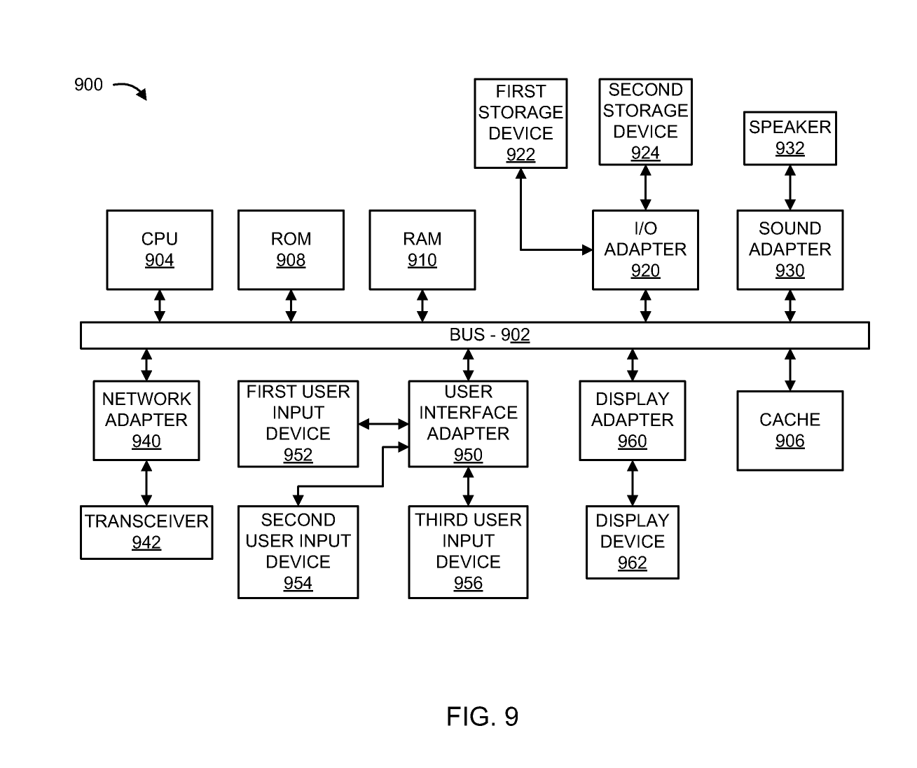

Now referring to FIG. 9, an exemplary processing system 900 to which the present principles may be applied is illustratively depicted in accordance with one embodiment of the present principles. The processing system 900 includes at least one processor (“CPU”) 904 operatively coupled to other components via a system bus 902. A cache 906, a Read Only Memory (“ROM”) 908, a Random Access Memory (“RAM”) 910, an input/output (“I/O”) adapter 920, a sound adapter 930, a network adapter 940, a user interface adapter 950, and a display adapter 960, are operatively coupled to the system bus 902.

A storage device 922 and a second storage device 924 are operatively coupled to system bus 902 by the I/O adapter 920. The storage devices 922 and 924 can be any of a disk storage device (e.g., a magnetic or optical disk storage device), a solid state magnetic device, and so forth. The storage devices 922 and 924 can be the same type of storage device or different types of storage devices.

A speaker 932 is operatively coupled to system bus 902 by the sound adapter 930. A transceiver 942 is operatively coupled to system bus 902 by network adapter 940. A display device 962 is operatively coupled to system bus 902 by display adapter 960.

A first user input device 952, a second user input device 954, and a third user input device 956 are operatively coupled to system bus 902 by user interface adapter 950. The user input devices 952, 954, and 956 can be any of a keyboard, a mouse, a keypad, an image capture device, a motion sensing device, a microphone, a device incorporating the functionality of at least two of the preceding devices, and so forth. Of course, other types of input devices can also be used. The user input devices 952, 954, and 956 can be the same type of user input device or different types of user input devices. The user input devices 952, 954, and 956 are used to input and output information to and from system 900.

Of course, the processing system 900 may also include other elements (not shown), as readily contemplated by one of skill in the art, as well as omit certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 900 are readily contemplated by one of ordinary skill in the art given the teachings of the present principles provided herein.

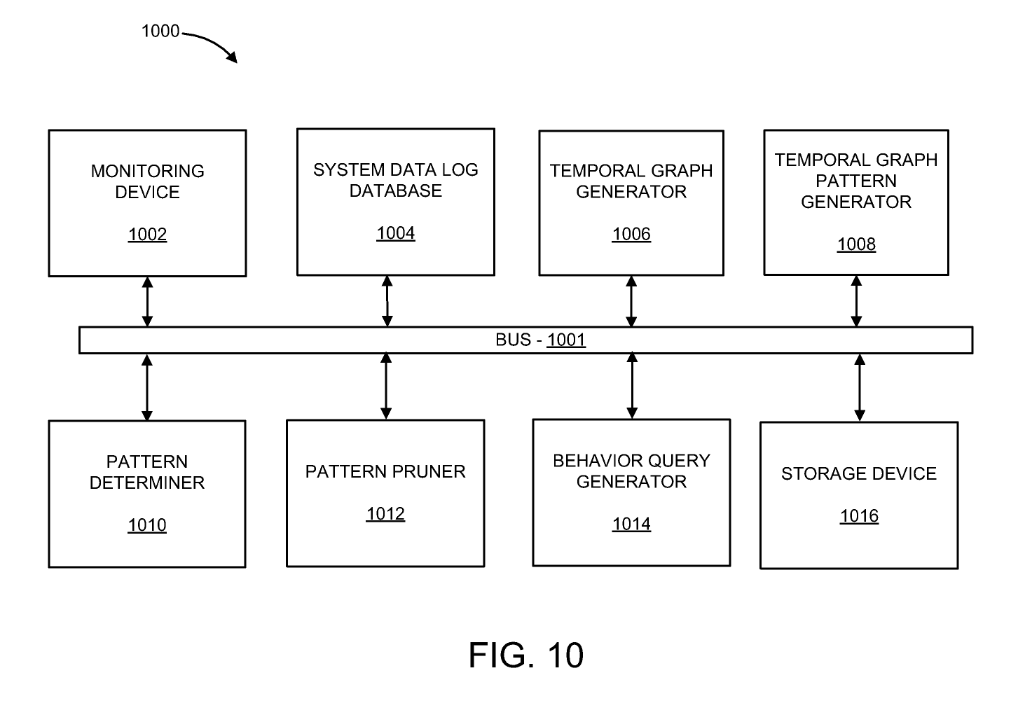

Moreover, it is to be appreciated that system 1000 described below, with respect to FIG. 10, is a system for implementing respective embodiments of the present principles. Part or all of processing system 900 may be implemented in one or more of the elements of system 1000.

Further, it is to be appreciated that processing system 900 may perform at least part of the method described herein including, for example, at least part of method 100 of FIG. 1. Similarly, part or all of system 1000 may be used to perform at least part of method 100 of FIG. 1.

FIG. 10 shows an exemplary system 1000 for constructing behavior queries in temporal graphs using discriminative sub-trace mining, in accordance with one embodiment of the present principles. While many aspects of system 1000 are described in singular form for the sake of illustration and clarity, the same can be applied to multiple ones of the items mentioned with respect to the description of system 1000. For example, while a pattern pruner 1010 is described, more than one pattern pruners 1010 may be used in accordance with the teachings of the present principles.

The system 1000 may include a monitoring device 1002, a system data log database 1004, a temporal graph generator 1006, a temporal graph pattern generator 1008, a pattern determiner 1010, a pattern pruner 1012, a behavior query generator 1014, and a storage device 1016.

The monitoring device 1002 may be configured to monitoring system data of a computer system. For example, the monitoring device 1002 may monitor execution of behavior traces at the computer system. In addition, the monitoring device 1002 may be configured to generate system data logs, which may be stored in the system data log database 1004 and may be accessed by various components of the system 1000. As described above, system data logs may include raw system behaviors, target behaviors and/or background behaviors, and may be monitored and collected by monitoring device 1002 and may be employed as input data. In addition, the system data logs may include information relating to how system entities interact with each other at the operating system and may include timestamps. In a further embodiment, monitoring device 1002 may be configured to monitor system data in a closed environment, where target behaviors and/or background behaviors are performed independently of each other.

The temporal graph generator 1006 may be configured to provide temporal graphs corresponding to the system data logs. In an embodiment, the temporal graph generator 1006 may be configured to provide a first temporal graph corresponding to a target behavior and a second temporal graph corresponding to a set of background behaviors. In a further embodiment, temporal graph generator 1006 may be configured to provide temporal subgraphs corresponding to the system data logs.

The temporal graph pattern generator 1008 may be configured to generate temporal graph patterns for each of the temporal graphs. For example, temporal graph pattern generator 1008 may provide a first temporal graph pattern for a first temporal graph and a second temporal graph pattern for a second temporal graph. In a further embodiment, the temporal graph pattern generator 1008 may generate temporal graph patterns that are T-connected graph patterns.

The pattern determiner 1010 may be configured to determine whether or not a pattern exits between the temporal graph patterns. For example, the pattern determiner 1010 may determine if a pattern exists between a first temporal graph pattern and a second temporal graph pattern. In a further embodiment, the pattern determiner 1010 may be configured to determine a non-repetitive graph pattern and/or consecutive graph pattern between the first and second temporal graph patterns. For example, the pattern determiner 1010 may determine a pattern between temporal graph patterns when each edge in a first temporal graph pattern corresponds to each edge in a second temporal graph pattern such that the node mappings between each edge are one-to-one. In a further embodiment, the pattern determiner 1010 may determine at least one of a forward growth pattern, a backward growth pattern, or an inward growth pattern, as described above. Advantageously, the pattern determiner 1010 may determine a non-repetitive pattern without the need for canonical labeling techniques.

The pattern pruner 1012 may be configured to prune the determined pattern to provide discriminative temporal graphs. In one embodiment, the pattern pruner 1012 may prune the patterns to select only those sub-relations with maximum frequency and/or maximum discriminative score. In a further embodiment, the pattern pruner 1012 may prune temporal sub-relations using subgraph pruning and/or supergraph pruning, as described above. In yet a further embodiment, the pattern pruner 1012 may be configured to prune the pattern between the temporal graph patterns by determining a set of residual graphs for each temporal graph pattern. In yet a further embodiment, the pattern pruner 1012 may be configured to minimize overhead from subgraph tests and minimize overhead from residual graph set equivalence tests.

The behavior query generator 1014 may be configured to generate behavior queries based on the discriminative temporal graphs. In an embodiment, behavior query generator 1014 may select patterns with the highest discriminative score as behavior queries to search target behavior activities from a repository of system data logs to determine if there are abnormal and/or suspicious activities occurring on a computer system. The behavior queries can then be stored on storage device 1016.

It should be noted that while the above configuration is illustratively depicted, it is contemplated that other sorts of configurations may also be employed according to the present principles. These and other variations between configurations are readily determined by one of ordinary skill in the art given the teachings of the present principles provided herein, while maintaining the present principles.

In some embodiments, monitoring device 1002, system data log database 1004, temporal graph generator 1006, temporal graph pattern generator 1008, pattern determiner 1010, pattern pruner 1012, behavior query generator 1014 and/or storage device 1016 of system 1000 may be a virtual appliance (e.g., computing device, node, server, etc.), and may be directly connected to a network or located remotely for controlling via any type of transmission medium (e.g., Internet, intranet, internet of things, etc.). In some embodiments, monitoring device 1002, system data log database 1004, temporal graph generator 1006, temporal graph pattern generator 1008, pattern determiner 1010, pattern pruner 1012, behavior query generator 1014 and/or storage device 1016 may be a hardware device, and may be attached to a network or built into a network according to the present principles.

In the embodiment shown in FIG. 10, the elements thereof are interconnected by a bus 1001. However, in other embodiments, other types of connections can also be used. Moreover, in one embodiment, at least one of the elements of system 1000 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 1100 are readily determined by one of ordinary skill in the art, given the teachings of the present principles provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A computer implemented method for constructing behavior queries in temporal graphs using discriminative sub-trace mining, comprising:
generating system data logs to provide temporal graphs, wherein the temporal graphs include at least a first temporal graph corresponding to a target behavior and a second temporal graph corresponding to a set of background behaviors;
generating temporal graph patterns for each of the first and second temporal graphs to determine whether a pattern exists between a first temporal graph pattern and a second temporal graph pattern, wherein the pattern between the temporal graph patterns is a non-repetitive graph pattern;
pruning the pattern between the temporal graph patterns to provide at least one discriminative temporal graph; and
generating behavior queries based on the at least one discriminative temporal graph.

2. The computer implemented method according to claim 1, wherein the pattern is determined when each edge in the first temporal graph pattern corresponds to each edge in the second temporal graph pattern such that node mappings between each edge are one-to-one.

3. The computer implemented method according to claim 1, wherein the pattern includes temporal graph patterns that are identical in linear time.

4. The computer implemented method according to claim 1, wherein the system data logs are generated in a closed environment such that the at least one target behavior is performed independently from the set of background behaviors.

5. The computer implemented method according to claim 1, wherein the pattern includes a consecutive growth pattern.

6. The computer implemented method according to claim 5, wherein the consecutive growth pattern includes at least one of a forward growth pattern, a backward growth pattern, and an inward growth pattern.

7. The computer implemented method according to claim 1, wherein the temporal graphs are T-connected temporal graphs.

8. The computer implemented method according to claim 1, wherein pruning includes at least one of subgraph pruning and supergraph pruning.

9. The computer implemented method according to claim 1, further comprising minimizing overheard from at least one of subgraph tests and residual graph set equivalence tests.

10. A system for constructing behavior queries in temporal graphs using discriminative sub-trace mining, comprising:
a monitoring device to generate system data logs to provide temporal graphs, wherein the temporal graphs include at least a first temporal graph corresponding to a target behavior and a second temporal graph corresponding to a set of background behaviors;
a temporal graph pattern generator to generate temporal graph patterns for each of the first and second temporal graphs;
a pattern determiner to determine whether a pattern exists between a first temporal graph pattern and a second temporal graph pattern, wherein the pattern between the temporal graph patterns is a non-repetitive graph pattern;
a pattern pruner comprising a processor, coupled to a bus, to prune the pattern between the temporal graph patterns to provide at least one discriminative temporal graph; and
a behavior query generator, coupled to the bus, to generate behavior queries based on the at least one discriminative temporal graph.

11. The system according to claim 10, wherein the pattern is determined when each edge in the first temporal graph pattern corresponds to each edge in the second temporal graph pattern such that node mappings between each edge are one-to-one.

12. The system according to claim 10, the monitoring device is further configured to generate the system data logs in a closed environment such that the at least one target behavior is performed independently from the set of background behaviors.

13. The system according to claim 10, wherein the pattern includes a consecutive growth pattern.

14. The system according to claim 13, wherein the consecutive growth pattern includes at least one of a forward growth pattern, a backward growth pattern, and an inward growth pattern.

15. The system according to claim 11, wherein the pattern pruner is further configured to prune using at least one of subgraph pruning and supergraph pruning.

16. A computer program product comprising a non-transitory computer readable storage medium having computer readable program code embodied therein for a method for constructing behavior queries in temporal graphs using discriminative sub-trace mining, the method comprising:
generating system data logs to provide temporal graphs, wherein the temporal graphs include at least a first temporal graph corresponding to a target behavior and a second temporal graph corresponding to a set of background behaviors;
generating temporal graph patterns for each of the first and second temporal graphs to determine whether a pattern exists between a first temporal graph pattern and a second temporal graph pattern, wherein the pattern between the temporal graph patterns is a non-repetitive graph pattern;
pruning the pattern between the temporal graph patterns to provide at least one discriminative temporal graph; and
generating behavior queries based on the at least one discriminative temporal graph.

17. The computer program product of claim 16, wherein the pattern is determined when each edge in the first temporal graph pattern corresponds to each edge in the second temporal graph pattern such that node mappings between each edge are one-to-one.

18. The computer program product of claim 16, wherein the system data logs are generated in a closed environment such that the at least one target behavior is performed independently from the set of background behaviors.

19. The computer program product of claim 16, wherein pruning includes at least one of subgraph pruning and supergraph pruning.

20. The computer program product of claim 19, further comprising minimizing overheard from at least one of subgraph tests and residual graph set equivalence tests.
